(19) United States
(12) Patent Application Publication
(10) Pub. No.: US 2021/0057971 A1
(43) Pub. Date: Feb. 25, 2021

(54) METHOD AND APPARATUS FOR MANUFACTURING STATOR

(71) Applicant: DENSO CORPORATION, Kariya-city (JP)

(72) Inventors: Hiroaki TAKEDA, Kariya-city (JP); Toshihiro TAKEI, Kariya-city (JP)

(73) Assignee: DENSO CORPORATION, Kariya-city (JP)

(21) Appl. No.: 16/998,150

(22) Filed: Aug. 20, 2020

(30) Foreign Application Priority Data
Aug. 20, 2019 (JP) 2019-150552

(51) Int. Cl. H02K 15/085; H02K 15/02; H02K 15/10

(52) U.S. Cl. CPC H02K 15/085; H02K 15/105; H02K 15/024

(57) ABSTRACT

A method of manufacturing a stator includes steps of: inserting a stator coil into slots of a stator core so as to have parts of the stator coil protruding from an axial end face of the stator core; and bending the protruding parts of the stator coil in a circumferential direction. Moreover, in the bending step: a bending jig with a press surface is arranged on the axial end face of the stator core to cover at least part of a corresponding tooth of the stator core; and at least one of the protruding parts is pressed against the press surface of the bending jig, thereby being bent in the circumferential direction. Furthermore, a circumferential width of the press surface is larger than a circumferential width of a facing part of the corresponding tooth; the facing part faces the at least one of the protruding parts in the circumferential direction.

### CROSS-REFERENCE TO RELATED APPLICATION

This application is based on and claims priority from Japanese Patent Application No. 2019-150552 filed on Aug. 20, 2019, the contents of which are hereby incorporated by reference in their entirety into this application.

### BACKGROUND

1 Technical Field

The present disclosure relates to methods and apparatuses for manufacturing stators for use in rotating electric machines.

2 Description of Related Art

There is known a method of manufacturing a stator coil of a rotating electric machine. This method includes a bending step in which: bending jigs (or bending members) are arranged on an axial end face of a stator core; and electrical conductor segments for forming the stator coil, which have been inserted in corresponding slots of the stator core in an insertion step prior to the bending step, are bent respectively along corresponding ones of the bending jigs. More specifically, in the bending step, each of the electrical conductor segments is bent by being pressed against both a first copying surface (or first shaping surface) formed at an opening edge of the corresponding slot of the stator core and a second copying surface (or second shaping surface) formed in the corresponding bending jig.

### SUMMARY

According to the present disclosure, there is provided a method of manufacturing a stator for a rotating electric machine. The stator includes: a hollow cylindrical stator core having a plurality of teeth arranged at predetermined intervals in a circumferential direction of the stator core and a plurality of slots each of which is formed between one circumferentially-adjacent pair of the teeth; and a stator coil mounted on the stator core so as to be received in the slots of the stator core, the stator coil including an electrical conductor and an insulating coat covering the electrical conductor. The method includes steps of: inserting the stator coil into the slots of the stator core so as to have a plurality of parts of the stator coil protruding from an axial end face of the stator core, the protruding parts together constituting a coil end of the stator coil; and bending the protruding parts of the stator coil in the circumferential direction. Moreover, in the bending step: a bending jig, which has a press surface, is arranged on the axial end face of the stator core to cover at least part of a corresponding one of the teeth of the stator core; and at least one of the protruding parts of the stator coil is pressed against the press surface of the bending jig, thereby being bent in the circumferential direction. Furthermore, a circumferential width of the press surface of the bending jig is larger than a circumferential width of a facing part of the corresponding tooth of the stator core; the facing part faces the at least one of the protruding parts of the stator coil in the circumferential direction.

According to the present disclosure, there is also provided an apparatus for manufacturing a stator for a rotating electric machine. The stator includes: a hollow cylindrical stator core having a plurality of teeth arranged at predetermined intervals in a circumferential direction of the stator core and a plurality of slots each of which is formed between one circumferentially-adjacent pair of the teeth; and a stator coil mounted on the stator core so as to be received in the slots of the stator core, the stator coil having a plurality of protruding parts that protrude from an axial end face of the stator core and together constitute a coil end of the stator coil. The apparatus includes: a bending jig having a press surface and configured to be arranged on the axial end face of the stator core to cover at least part of a corresponding one of the teeth of the stator core; and a pressing device configured to press at least one of the protruding parts of the stator coil against the press surface of the bending jig, thereby bending the at least one of the protruding parts in the circumferential direction. Moreover, a circumferential width of the press surface of the bending jig is larger than a circumferential width of a facing part of the corresponding tooth of the stator core; the facing part faces the at least one of the protruding parts of the stator coil in the circumferential direction.

### BRIEF DESCRIPTION OF THE DRAWINGS

FIG. 1 is a schematic cross-sectional view of a rotating electric machine which includes a stator according to a first embodiment.

FIG. 2 is a schematic cross-sectional view of part of the stator.

FIG. 3 is a schematic perspective view illustrating the manner of inserting electrical conductor segments forming a stator coil into slots of a stator core of the stator.

FIG. 4 is a schematic perspective view illustrating the electrical conductor segments in a state of having been inserted in the slots of the stator core.

FIG. 5 is a schematic cross-sectional view illustrating the configuration of insulating sheets of the stator.

FIG. 6 is an exploded perspective view illustrating part of the stator core, one insulating sheet to be inserted in one of the slots of the stator core, and the electrical conductor segments to be inserted inside the insulating sheet.

FIG. 7 is a flowchart illustrating a method of manufacturing the stator according to the first embodiment.

FIG. 8 is a schematic cross-sectional view illustrating part of an apparatus for manufacturing the stator according to the first embodiment.

FIG. 9 is a schematic perspective view illustrating one of bending jigs of the manufacturing apparatus which is arranged between circumferentially-adjacent protruding parts of the electrical conductor segments.

FIG. 10 is a schematic top view illustrating one of the bending jigs which is arranged between circumferentially-adjacent protruding parts of the electrical conductor segments.

FIG. 11 is a schematic cross-sectional view illustrating the positional and dimensional relationships between the bending jigs and the stator according to the first embodiment.

FIG. 12 is a schematic diagram illustrating a bending step of the method of manufacturing the stator according to the first embodiment.

FIG. 13 is a schematic cross-sectional view illustrating the positional and dimensional relationships between the bending jigs and a stator according to a second embodiment.

FIG. 14 is a schematic diagram illustrating a bending step of a method of manufacturing the stator according to the second embodiment.

### DESCRIPTION OF EMBODIMENTS

The inventors of the present application have found, through investigation, that the above-described manufacturing method known in the art (see, for example, Japanese Patent No. JP3975947B2) may involve the following problem. That is, in the bending step of the manufacturing method, each of the electrical conductor segments is bent by being pressed against both the first copying surface formed in the stator core and the second copying surface formed in the corresponding bending jig. However, depending on the manufacturing accuracy, the actual position of the corresponding bending jig relative to the stator core may be deviated from a desired position. Consequently, the actual positional relationship between the first and second copying surfaces would also be deviated from a desired positional relationship, resulting in an error in the shape of the electrical conductor segment bent in the bending step. As a result, there would be variation in the shape of the finally-obtained stator coil.

In contrast, in the above-described method according to the present disclosure, the bending jig is configured so that the circumferential width of the press surface of the bending jig is larger than the circumferential width of the facing part of the corresponding tooth. With this configuration, in the bending step, it becomes possible to bend the at least one of the protruding parts of the stator coil along the press surface of the bending jig while keeping the at least one of the protruding parts out of contact with the axial end face of the stator core. That is, in the method according to the present disclosure, the at least one of the protruding parts of the stator coil is bent not along both the axial end face of the stator core and the press surface of the bending jig, but along only the press surface of the bending jig. Consequently, even when the actual positional relationship between the axial end face of the stator core and the press surface of the bending jig is deviated from a desired positional relationship, it will still be possible to form the coil end of the stator coil into a stable curved shape conforming to the press surface of the bending jig. Hence, with the method according to the present disclosure, it becomes possible to manufacture the stator without causing variation in the shape of the stator coil.

In a further implementation of the above-described manufacturing method according to the present disclosure, in the bending step, the bending jig may be inserted, in a radial direction of the stator core, between at least one pair of the protruding parts of the stator coil located respectively on opposite circumferential sides of the corresponding tooth of the stator core. In this case, it is possible to arrange the bending jig on the axial end face of the stator core without causing interference between the bending jig and the at least one pair of the protruding parts of the stator coil. Moreover, it is also possible for the bending jig to be shared by the at least one pair of the protruding parts of the stator coil. Consequently, it is possible to simplify the bending step; it is also possible to reduce the parts count of the manufacturing apparatus.

The press surface of the bending jig may be configured as a curved surface having at least one radius of curvature. In the bending step, the bending jig may be arranged on the axial end face of the stator core so as to allow the at least one of the protruding parts of the stator coil to be bent without making contact with the axial end face of the stator core. With the above configuration of the press surface of the bending jig, it is possible to mitigate stress acting on the insulating coat of the stator coil during the bending of the at least one of the protruding parts, thereby protecting the insulating coat. Moreover, with the above arrangement of the bending jig on the axial end face of the stator core, it is possible to prevent the insulating coat of the stator coil from being damaged due to contact between the stator coil and the axial end face of the stator core.

Between the stator coil and each of the teeth of the stator core, there may be interposed an insulating member to electrically insulate the stator coil from the stator core. In the bending step, the insulating member interposed between the at least one of the protruding parts of the stator coil and the bending jig may also be bent, together with the at least one of the protruding parts, in the circumferential direction. As described previously, in the bending step of the manufacturing method according to the present disclosure, the stator coil is kept out of contact with the axial end face of the stator core. Accordingly, it is difficult for the insulating member to make contact with the axial end face of the stator core in the bending step. Consequently, the insulating member can be prevented from being damaged due to contact with the axial end face of the stator core.

The bending jig may be formed of a material having a higher Young's modulus than the insulating coat of the stator coil. In this case, it is possible to secure high rigidity of the bending jig, thereby making it difficult for the bending jig to be deformed during the bending of the at least one of the protruding parts of the stator coil along the press surface thereof. As a result, it is possible to suppress variation in the shape of the stator coil.

The bending jig may be formed of a material having a higher yield point than the insulating coat of the stator coil. In this case, it is difficult for the bending jig to be deformed during the bending of the at least one of the protruding parts of the stator coil along the press surface thereof. As a result, it is possible to suppress variation in the shape of the stator coil.

The rotating electric machine may include a protector that is configured to limit an output of the rotating electric machine upon the temperature of a heat-generating part of the rotating electric machine exceeding a predetermined threshold temperature. When there is variation in the shape of the stator coil, it may become difficult to dissipate heat from the heat-generating part of the rotating electric machine, resulting in an excessive increase in the temperature of the heat-generating part. In this case, the protector would frequently operate to limit the output of the rotating electric machine, so as to suppress increase in the temperature of the heat-generating part. In contrast, with the manufacturing method according to the present disclosure, variation in the shape of the stator coil can be suppressed, thereby preventing frequent operation of the protector.

The manufacturing method according to the present disclosure may further include, after the bending step, a step of fixing the stator coil to the stator core with an adhesive member. According to the manufacturing method known in the art, the at least one of the protruding parts of the stator coil would be bent along both the axial end face of the stator core and the press surface of the bending jig. In this case, the stator coil would be placed in intimate contact with the stator core. Consequently, it would be difficult to secure a space for arranging the adhesive member between the stator core and the stator coil. In contrast, in the bending step of the manufacturing method according to the present disclosure, the stator coil is kept out of contact with the axial end face of the stator core. Consequently, it is possible to secure the spaces for arranging the adhesive members between the stator core and the stator coil. In other words, it is possible to have the adhesive member suitably interposed between the stator core and the stator coil. As a result, it is possible to firmly fix the stator coil to the stator core, thereby lowering vibration and noise of the rotating electric machine.

Moreover, in the above-described apparatus according to the present disclosure, the bending jig is configured so that the circumferential width of the press surface of the bending jig is larger than the circumferential width of the facing part of the corresponding tooth. With this configuration, the at least one of the protruding parts of the stator coil is bent not along both the axial end face of the stator core and the press surface of the bending jig, but along only the press surface of the bending jig. Consequently, even when the actual positional relationship between the axial end face of the stator core and the press surface of the bending jig is deviated from a desired positional relationship, it will still be possible to form the coil end of the stator coil into a stable curved shape conforming to the press surface of the bending jig. Hence, with the apparatus according to the present disclosure, it becomes possible to manufacture the stator without causing variation in the shape of the stator coil.

Exemplary embodiments will be described hereinafter with reference to the drawings. It should be noted that for the sake of clarity and understanding, identical components having identical functions throughout the whole description have been marked, where possible, with the same reference numerals in each of the figures and that for the sake of avoiding redundancy, descriptions of identical components will not be repeated.

### First Embodiment

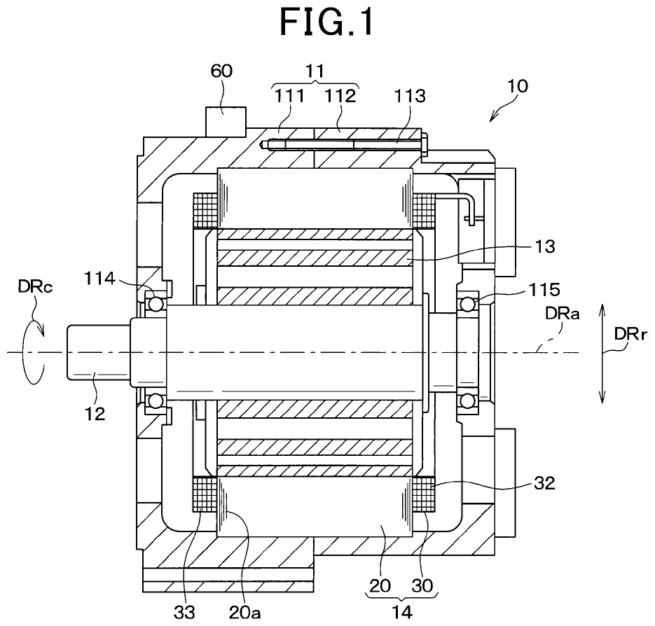

FIG. 1 shows the overall configuration of a rotating electric machine 10 which includes a stator 14 according to the first embodiment.

In the present embodiment, the rotating electric machine 10 is configured as an automotive alternator. Though not shown in the figures, the automotive alternator is mounted in a vehicle and driven by an engine of the vehicle to generate electric power; the generated electric power is then used to charge an in-vehicle battery and feed electrical loads provided in the vehicle. In addition, the automotive alternator may be, for example, of a three-phase synchronous type.

As shown in FIG. 1, the rotating electric machine 10 includes a housing 11, a rotating shaft 12, a rotor 13 fixed on the rotating shaft 12, and the stator 14 provided at such a position as to surround the rotor 13.

It should be noted that for the sake of facilitating understanding, axial, radial and circumferential directions of the rotating shaft 12, the rotor 13 and the stator 14 are respectively denoted by □DRa□, □DRr□ and □DRc□ in the figures. In addition, the radial direction DRr is perpendicular to the axial direction DRa.

The housing 11 is configured to receive both the rotor 13 and the stator 14 therein. More particularly, in the present embodiment, the housing 11 is composed of a pair of cup-shaped housing pieces 111 and 112. The housing pieces 111 and 112 are assembled together so as to have opening edges thereof abutting each other, and fastened into one piece by fastening means such as bolts 113.

The housing 11 has a pair of bearings 114 and 115 provided respectively in opposite axial end walls thereof. The rotating shaft 12 and the rotor 13 are rotatably supported by the housing 11 via the pair of bearings 114 and 115.

The rotor 13 is located radially inside the stator 14. The rotor 13 may be configured as, for example, a Lundell-type rotor. Though not shown in the figures, the rotor 13 has a plurality of magnetic poles provided on a radially outer periphery thereof facing a radially inner periphery of the stator 14. The magnetic poles are arranged at predetermined intervals in the circumferential direction DRc such that the polarities of the magnetic poles are alternately different in the circumferential direction DRc. In addition, the magnetic poles may be formed, for example, of a plurality of permanent magnets embedded in a rotor core (or iron core) of the rotor 13.

In the present embodiment, the number of the magnetic poles of the rotor 13 is set to 8. That is, the rotor 13 has four N poles and four S poles. In addition, it should be noted that the number of the magnetic poles is not limited to 8, but may alternatively be set to any other suitable number.

The stator 14 is located radially outside the rotor 13. The stator 14 is configured to generate electric power upon receiving magnetic flux from the rotor 13. Specifically, the stator 14 includes a hollow cylindrical (or annular) stator core 20 having a plurality of slots 210 formed therein and a three-phase stator coil 30 mounted on the stator core 20 so as to be received in the slots 210.

In the present embodiment, the stator core 20 is constituted of a laminate that is formed by laminating a plurality of annular magnetic steel sheets 20a in the axial direction DRa. It should be appreciated that other conventional metal sheets may also be used instead of the magnetic steel sheets.

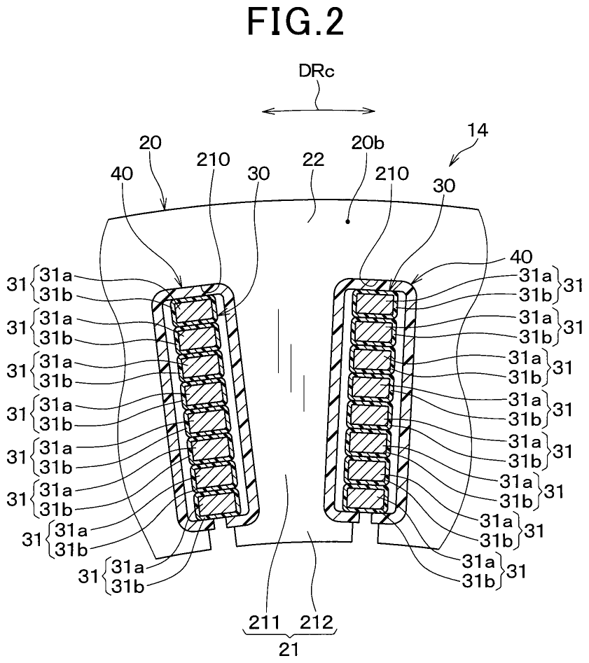

As shown in FIG. 2, the stator core 20 includes an annular back core 22 and a plurality of teeth 21 in addition to the aforementioned slots 210. The back core 22 constitutes a radially outer peripheral part of the stator core 20. The teeth 21 each protrude radially inward from the back core 22 and are arranged at predetermined intervals in the circumferential direction DRc. Each of the slots 210 is formed between one circumferentially-adjacent pair of the teeth 21. In addition, each of the slots 210 extends in the axial direction DRa to axially penetrate the stator core 20.

In the present embodiment, each of the teeth 21 has a main body 211, on which the stator coil 30 is wound, and a flange 212 formed at a distal end (or radially inner end) of the main body 211 to protrude from the main body 211 to both sides in the circumferential direction DRc. The main body 211 constitutes a facing part of the tooth 21 which faces the stator coil 30 in the circumferential direction DRc. The flange 212 is provided for positioning the stator coil 30 in the radial direction DRr.

Moreover, in the present embodiment, the number of the slots 210 per magnetic pole of the rotor 13 and per phase of the stator coil 30 is equal to 2. In other words, the slot multiplier number is equal to 2. Accordingly, the total number of the slots 210 formed in the stator core 20 is equal to 48 (i.e., 2×8×3). In addition, the forty-eight slots 210 are comprised of pairs of U-phase slots, V-phase slots and W-phase slots which are sequentially and repeatedly arranged in the circumferential direction DRc.

In the present embodiment, each of the slots 210 is formed to be longer in the radial direction DRr than in the circumferential direction DRc, so as to have a plurality of electrical conductor segments 31 arranged therein in radial alignment with each other. The electrical conductor segments 31 will be described in detail later. Moreover, each of the slots 210 is configured as a partially-closed slot which is partially closed at a radially inner end thereof by the flanges 212 of one circumferentially-adjacent pair of the teeth 21. In other words, each of the slots 210 partially opens on the radially inner surface of the stator core 20.

It should be noted that each of the slots 210 may alternatively be configured as a closed slot which is completely closed at the radially inner end thereof by a circumferentially-extending inner wall portion of the stator core 20.

In the present embodiment, the stator coil 30 is formed of a plurality of electrical conductor segments 31. The electrical conductor segments 31 are obtained by cutting and plastically deforming an electric wire that includes an electrical conductor 31a and an insulating coat 31b. The electrical conductor 31a is formed of an electrically conductive material (e.g., copper) and has a substantially rectangular cross section. The insulating coat 31b is formed of an electrically insulative resin and provided to cover the outer surface of the electrical conductor 31a.

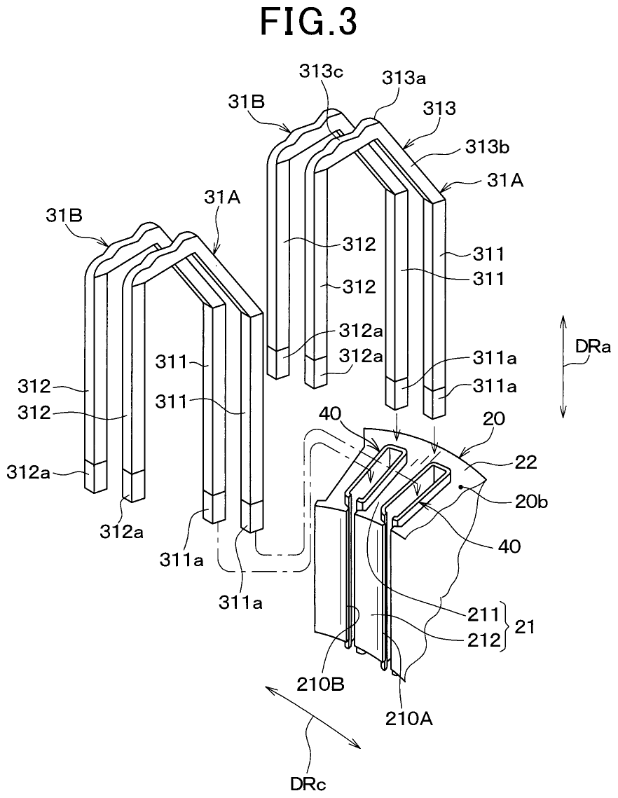

As shown in FIG. 3, each of the electrical conductor segments 31 is substantially U-shaped to have a pair of straight portions 311 and 312 extending parallel to each other and a turn portion 313 connecting ends of the straight portions 311 and 312 on the same side. The straight portions 311 and 312 have a length greater than the length of the stator core 20 in the axial direction DRa.

The turn portion 313 has an apex part 313a formed at the center thereof so as to extend parallel to a first axial end face 20b (i.e., the upper end face in FIG. 3) of the stator core 20. The turn portion 313 also has a pair of oblique parts 313b and 313c formed respectively on opposite sides of the apex part 313a so as to extend obliquely at a predetermined angle with respect to the first axial end face 20b of the stator core 20.

Moreover, as shown in FIG. 3, the insulating coat 31b is removed from distal end portions of the straight portions 311 and 312 of the electrical conductor segments 31 (i.e., end portions of the straight portions 311 and 312 on the opposite side to the turn portions 313). Consequently, the distal end portions of the straight portions 311 and 312 of the electrical conductor segments 31 constitute exposed portions 311a and 312a where the electrical conductor 31a is exposed from the insulating coat 31b.

In addition, to allow each of the straight portions 311 and 312 of the electrical conductor segments 31 to be inserted in a corresponding one of the slots 210 of the stator core 20, the width of each of the straight portions 311 and 312 in the circumferential direction DRc is set to be smaller than the width of each of the slots 210 in the circumferential direction DRc.

As mentioned previously, in the present embodiment, the slots 210 of the stator core 20 are comprised of a plurality of slot pairs each consisting of a first slot 210A and a second slot 210B; the first and second slots 210A and 210B are adjacent to each other in the circumferential direction DRc and belong to the same phase (i.e., the same one of the U, V, and W phases). On the other hand, the electrical conductor segments 31 forming the stator coil 30 are comprised of a plurality of electrical conductor segment pairs each consisting of a first electrical conductor segment 31A and a second electrical conductor segment 31B; the first and second electrical conductor segments 31A and 31B have the same shape and size.

For each electrical conductor segment pair, the straight portions 311 and 312 of the first electrical conductor segment 31A are inserted, from a first axial side (i.e., the upper side in FIG. 3) of the stator core 20, respectively into the first slot 210A of a first slot pair and the first slot 210A of a second slot pair; the straight portions 311 and 312 of the second electrical conductor segment 31B are inserted, from the first axial side of the stator core 20, respectively into the second slot 210B of the first slot pair and the second slot 210B of the second slot pair. That is, the first and second electrical conductor segments 31A and 31B are circumferentially offset from each other by one slot-pitch. In addition, the first slot pair and the second slot pair are located away from each other by one magnetic pole pitch (or six slot-pitches).

For example, in the case of the electrical conductor segment pair which is shown on the upper right side in FIG. 3, the first electrical conductor segment 31A has its right straight portion 311 inserted in the eighth layer (i.e., the radially outermost layer) of the first slot 210A shown in FIG. 3 and its left straight portion 312 inserted in the seventh layer of the first slot 210A (not shown) that is located away from the first slot 210A shown in FIG. 3 counterclockwise by one magnetic pole pitch. On the other hand, the second electrical conductor segment 31B has its right straight portion 311 inserted in the eighth layer of the second slot 210B shown in FIG. 3 and its left straight portion 312 inserted in the seventh layer of the second slot 210B (not shown) that is located away from the second slot 210B shown in FIG. 3 counterclockwise by one magnetic pole pitch.

In the above manner, in each of the slots 210 of the stator core 20, there are inserted an even number of the straight portions 311 and 312 of the electrical conductor segments 31. More particularly, in the present embodiment, as shown in FIG. 2, in each of the slots 210 of the stator core 20, there are inserted eight straight portions 311 and 312 of the electrical conductor segments 31 so as to be radially stacked in eight layers in the slot 210.

Moreover, in the present embodiment, as shown in FIGS. 2-4, in each of the slots 210 of the stator core 20, there is provided one insulating sheet 40 to electrically insulate between the stator core 20 and the stator coil 30 (i.e., the electrical conductor segments 31). The insulating sheet 40 is bent according to the shape and size of the plurality (e.g., eight in the present embodiment) of electrical conductor segments 31 inserted in the slot 210 and arranged to surround all of the plurality of electrical conductor segments 31 together. Consequently, the insulating sheet 40 is placed in a state of being sandwiched between an interior wall surface of the stator core 20 defining the slot 210 and the electrical conductor segments 31 inserted in the slot 210. In addition, the insulating sheet 40 protrudes outside the slot 210 from both the axial end faces 20b of the stator core 20.

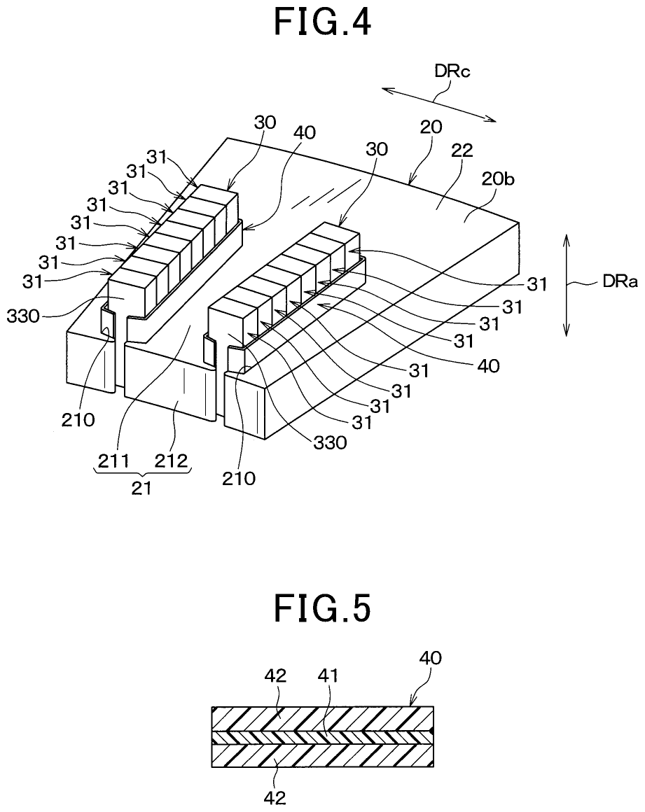

After the insertion of the straight portions 311 and 312 of the electrical conductor segments 31 into the corresponding slots 210 of the stator core 20, as shown in FIG. 4, in each of the electrical conductor segments 31, parts of the straight portions 311 and 312 on the opposite side to the turn portion 313 protrude outside the corresponding slots 210 on a second axial side (i.e., the upper side in FIG. 4) of the stator core 20. That is, each of the electrical conductor segments 31 has a pair of protruding parts 330 that protrude outside the corresponding slots 210 from a second axial end face 20b (i.e., the upper end face in FIG. 4) of the stator core 20.

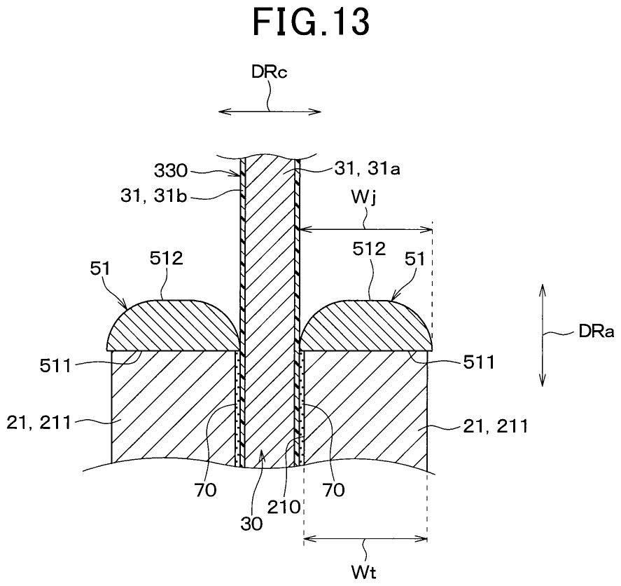

The protruding parts 330 of the electrical conductor segments 31 are then bent so as to extend obliquely at a predetermined angle with respect to the second axial end face 20b of the stator core 20 (see FIG. 12). More specifically, for each radially-adjacent pair of the protruding parts 330 of the electrical conductor segments 31, the protruding parts 330 of the pair are bent respectively to opposite sides in the circumferential direction DRc so as to become away from each other. Thereafter, for each corresponding pair of the protruding parts 330 of the electrical conductor segments 31, the protruding parts 330 of the pair are joined, for example by welding, at their respective distal end portions (i.e., exposed portions 311a and 312a). Consequently, all the electrical conductor segments 31 are electrically connected in a predetermined pattern, forming the stator coil 30.

Referring back to FIG. 1, the stator coil 30 mounted on the stator core 20 has an annular first coil end 32 on the first axial side (i.e., the right side in FIG. 1) of the stator core 20 and an annular second coil end 33 on the second axial side (i.e., the left side in FIG. 1) of the stator core 20. The first coil end 32 is constituted of the turn portions 313 of the electrical conductor segments 31 which protrude outside the corresponding slots 210 of the stator core 20 from the first axial end face 20b (i.e., the right end face in FIG. 1) of the stator core 20. On the other hand, the second coil end 33 is constituted of the protruding parts 330 of the electrical conductor segments 31 which protrude outside the corresponding slots 210 of the stator core 20 from the second axial end face 20b (i.e., the left end face in FIG. 1) of the stator core 20.

Next, the configuration of the insulating sheets 40, which are provided between the stator core 20 and the electrical conductor segments 31 forming the stator coil 30, will be described in detail with reference to FIG. 5.

As shown in FIG. 5, in the present embodiment, each of the insulating sheets 40 includes a sheet-like substrate 41 and a pair of resin layers 42 provided respectively on opposite major faces of the substrate 41.

The substrate 41 is formed of an electrically insulative resin, such as a PPS (polyphenylene sulfide) resin or a PEN (polyethylene naphthalate) resin, to have a predetermined strength.

The resin layers 42 are formed of a curable and foamable resin that is foamed and cured by external stimulation. More specifically, the curable and foamable resin is obtained by dispersing beads, which are foamable by thermal stimulation, in a thermosetting resin such as an epoxy resin. The resin layers 42 are formed by applying the curable and foamable resin to the major faces of the substrate 41. The resin layers 42 have a predetermined thickness in the range of, for example, several tens of micrometers to one millimeter. Of the pair of resin layers 42, that resin layer 42 which is provided on the outer major face of the substrate 41 is bonded to the interior wall surface of the stator core 20 defining the slot 210 while the other resin layer 42 which is provided on the inner major face of the substrate 41 is bonded to the stator coil 30. Therefore, the resin layers 42 can be regarded as adhesive layers.

In addition, the substrate 41 may alternatively be formed of a nonwoven fabric. The resin layers 42 may include, as the foaming agent, an acrylic resin or a urethane resin instead of the beads. Moreover, the resin layers 42 may be formed of, instead of the thermosetting resin, a UV-curable resin which is cured by irradiation of UV (ultraviolet) rays or an anaerobically curable resin that cures in the absence of air.

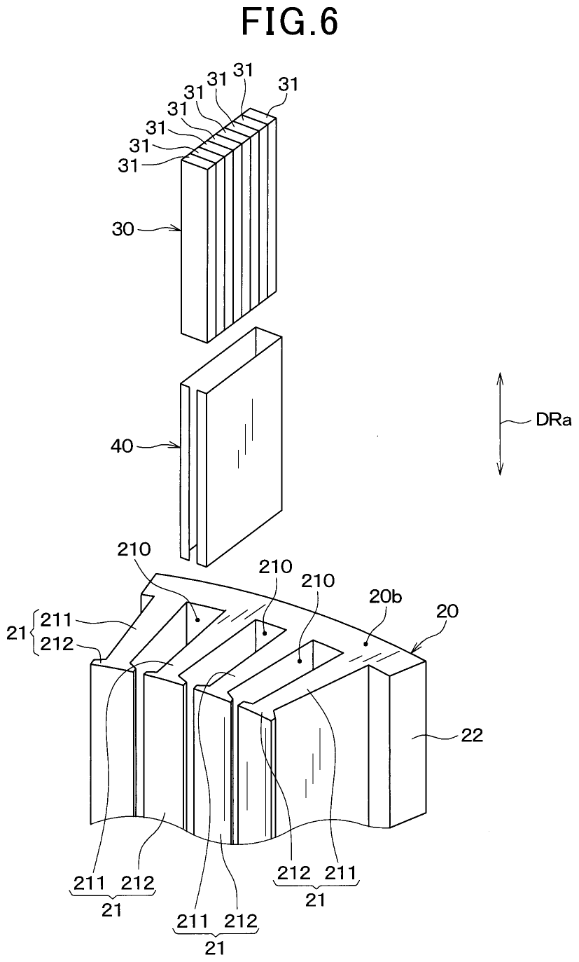

In manufacturing the stator 14, the insulating sheets 40 and the electrical conductor segments 31 (i.e., the stator coil 30) are assembled to the stator core 20 in a state as shown in FIG. 6. Specifically, as described previously, the electrical conductor segments 31 forming the stator coil 30 are assembled to the stator core 20 so that in each of the slots 210 of the stator core 20, there are inserted eight straight portions 311 and 312 of the electrical conductor segments 31 so as to be radially stacked in eight layers in the slot 210. The eight straight portions 311 and 312 of the electrical conductor segments 31 may be bonded together before being assembled to the stator core 20. Moreover, each of the insulating sheets 40 is bent at four positions (or bent into the shape of a rectangular tube) and inserted in a corresponding one of the slots 210 of the stator core 20 to surround all of the eight straight portions 311 and 312 of the electrical conductor segments 31 received in the corresponding slot 210.

Accordingly, in the present embodiment, the insulating sheets 40 serve as insulating members to electrically insulate the stator coil 30 from the stator core 20. Moreover, the resin layers 42 of the insulating sheets 40 serve as adhesive members to fix the stator coil 30 to the stator core 20.

During operation, the rotating electric machine 10 configured as described above generates heat, thereby increasing the temperature thereof. However, an excessive increase in the temperature of the rotating electric machine 10 may cause damage to the components of the rotating electric machine 10.

To solve the above problem, in the rotating electric machine 10, there is provided a protector 60 as shown in FIG. 1. The protector 60 is configured to limit the output of the rotating electric machine 10 upon the temperature of a heat-generating part (e.g., the second coil end 33 of the stator coil 30) of the rotating electric machine 10 exceeding a predetermined threshold temperature. Specifically, the protector 60 is configured with, for example, a temperature sensor that detects the temperature of a heat-generating part of the rotating electric machine 10 and a limiting circuit that changes (or limits) the output of the rotating electric machine 10 according to the temperature detected by the temperature sensor.

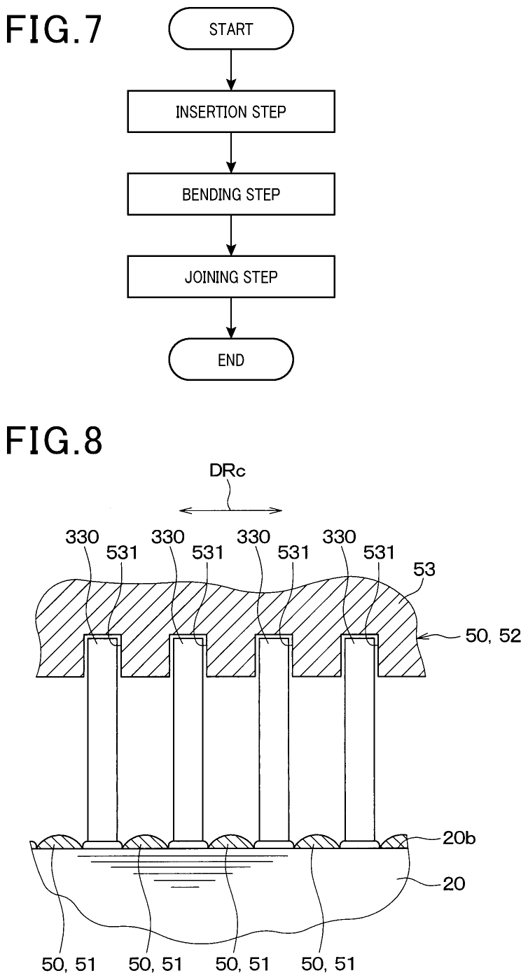

Next, a method of manufacturing the stator 14 according to the present embodiment will be described with reference to FIG. 7.

As shown in FIG. 7, the manufacturing method of the stator 14 according to the present embodiment includes an insertion step, a bending step and a joining step.

(Insertion Step)

In the insertion step, the stator coil 30 (more specifically, the electrical conductor segments 31 forming the stator coil 30) is inserted into the slots 210 of the stator core 20 so as to have the second coil end 33 of the stator coil 30 (more specifically, the protruding parts 330 of the electrical conductor segments 31 constituting the second coil end 33) protruding from the second axial end face 20b of the stator core 20.

More particularly, in the present embodiment, both the stator coil 30 and the insulating sheets 40 are inserted into the slots 210 of the stator core 20 so that in each of the slots 210, there is interposed one of the insulating sheets 40 between the stator core 20 and the stator coil 30. Specifically, in the insertion step, as shown in FIG. 4, the stator coil 30 and the insulating sheets 40 are inserted into the slots 210 of the stator core 20 so that parts of the insulating sheets 40 protrude, together with the protruding parts 330 of the electrical conductor segments 31, from the second axial end face 20b of the stator core 20.

In addition, in the present embodiment, the insulating sheets 40 are first inserted into the slots 210 of the stator core 20; then, the electrical conductor segments 31 forming the stator coil 30 are inserted into the slots 210 of the stator core 20 so that in each of the slots 210, eight straight portions 311 and 312 of the electrical conductor segments 31 are surrounded by one of the insulating sheets 40. Alternatively, the insulating sheets 40 may be first assembled to the electrical conductor segments 31 so that each of the insulating sheets 40 surrounds eight straight portions 311 and 312 of the electrical conductor segments 31; then, the electrical conductor segments 31 may be inserted, together with the insulating sheets 40 assemble thereto, into the slots 210 of the stator core 20.

(Bending Step)

In the bending step, the protruding parts 330 of the electrical conductor segments 31 are twisted and bent in the circumferential direction DRc. Specifically, in this step, bending jigs 51 are first arranged on the second axial end face 20b of the stator core 20; then, the protruding parts 330 of the electrical conductor segments 31 are bent in the circumferential direction DRc using the bending jigs 51.

More particularly, in the present embodiment, as shown in FIG. 8, the protruding parts 330 of the electrical conductor segments 31 are bent by an apparatus 50 for manufacturing the stator 14. The apparatus 50 includes the bending jigs 51 and a processing device 52.

The bending jigs 51 are provided to bend the protruding parts 330 of the electrical conductor segments 31, which together constitute the second coil end 33 of the stator coil 30, in the circumferential direction DRc. Each of the bending jigs 51 is arranged on the second axial end face 20b of the stator core 20 so as to be located between one adjacent pair of the slots 210 of the stator core 20 in the circumferential direction DRc.

The processing device 52 is provided to twist and bend the protruding parts 330 of the electrical conductor segments 31 in the circumferential direction DRc with the bending jigs 51 arranged on the second axial end face 20b of the stator core 20. The processing device 52 includes a shaping plate 53 and a lift unit (not shown). The shaping plate 53 has a plurality of receiving grooves 531 formed therein; each of the receiving grooves 531 receives therein the distal end portions of those protruding parts 330 of the electrical conductor segments 31 which protrude out from a corresponding one of the slots 210 of the stator core 20. The lift unit is configured to move up and down the shaping plate 53 while rotating the shaping plate 53 in the circumferential direction DRc.

In the bending step, the distal end portions of the protruding parts 330 of the electrical conductor segments 31 are first inserted in the corresponding receiving grooves 531 of the shaping plate 53. Then, the lift unit moves up and down the shaping plate 53 while rotating the same in the circumferential direction DRc, thereby bending the protruding parts 330 of the electrical conductor segments 31 along the surfaces (i.e., press surfaces 512 to be described later) of the corresponding bending jigs 51 in the circumferential direction DRc.

(Joining Step)

In the joining step, each corresponding pair of the protruding parts 330 of the electrical conductor segments 31 are joined to each other; and the stator coil 30 is fixed to the stator core 20.

More particularly, in the present embodiment, both a conductor segment joining process and a resin curing process are performed in the joining step. In the conductor segment joining process, each corresponding pair of the protruding parts 330 of the electrical conductor segments 31 are joined to each other by, for example, welding. In the resin curing process, the resin layers 42 of the insulating sheets 40 are foamed and cured, thereby fixing the stator coil 30 to the stator core 20.

Specifically, in the resin curing process, thermal stimulation is applied to the stator core 20 and the electrical conductor segments 31 at the same time, causing the resin layers 42 of the insulating sheets 40, which are received in the corresponding slots 210 of the stator core 20, to be foamed and cured.

In addition, in the present embodiment, the resin curing process is performed after the conductor segment joining process. However, it should be noted that the resin curing process may alternatively be performed before the conductor segment joining process.

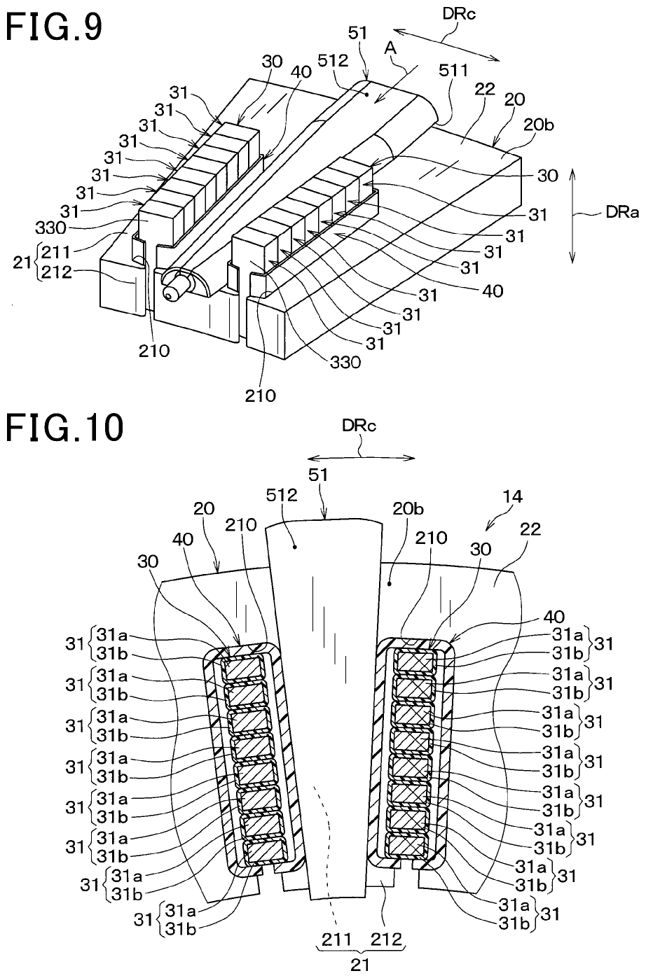

Next, the bending jigs 51 used in the bending step of the manufacturing method according to the present embodiment will be described in detail with reference to FIGS. 9-11.

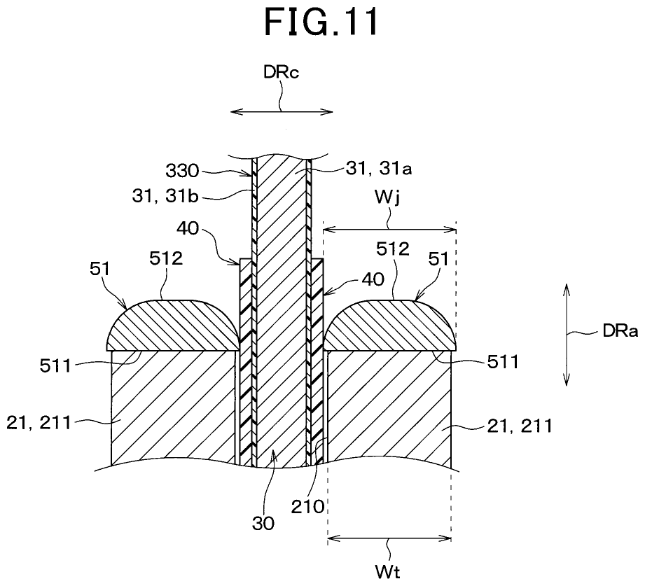

As shown in FIGS. 9 and 10, in the bending step, each of the bending jigs 51 is arranged on the second axial end face 20b of the stator core 20 so as to cover at least part of an axial end face of a corresponding one of the teeth 21 of the stator core 20. More particularly, in the present embodiment, each of the bending jigs 51 is arranged on the second axial end face 20b of the stator core 20 so as to overlap the entire main body 211 of the corresponding tooth 21 in the axial direction DRa.

Each of the bending jigs 51 has a lower end face 511 that faces the second axial end face 20b of the stator core 20 upon arrangement of the bending jig 51 on the second axial end face 20b, and an upper end face 512 that constitutes a press surface 512 against which the corresponding protruding parts 330 of the electrical conductor segments 31 are pressed in the bending step.

The lower end face 511 is formed as a flat surface so as to be substantially parallel to the second axial end face 20b of the stator core 20 upon arrangement of the bending jig 51 on the second axial end face 20b. It should be noted that the lower end face 511 may alternatively include a curved surface as a part thereof.

The press surface 512 faces the corresponding protruding parts 330 of the electrical conductor segments 31 in the circumferential direction DRc upon arrangement of the bending jig 51 on the second axial end face 20b of the stator core 20. More particularly, in the present embodiment, the press surface 512 is curved into a semicircular arc shape. It should be noted that the shape of the press surface 512 is not limited to the semicircular arc shape, but may alternatively be the shape of any other curved surface having at least one radius of curvature.

In the present embodiment, each of the teeth 21 of the stator core 20 is shaped so as to have its circumferential width increasing from the radially inner side to the radially outer side. To conform to the shape of the teeth 21, each of the bending jigs 51 is also shaped so as to have its circumferential width increasing from the radially inner side to the radially outer side.

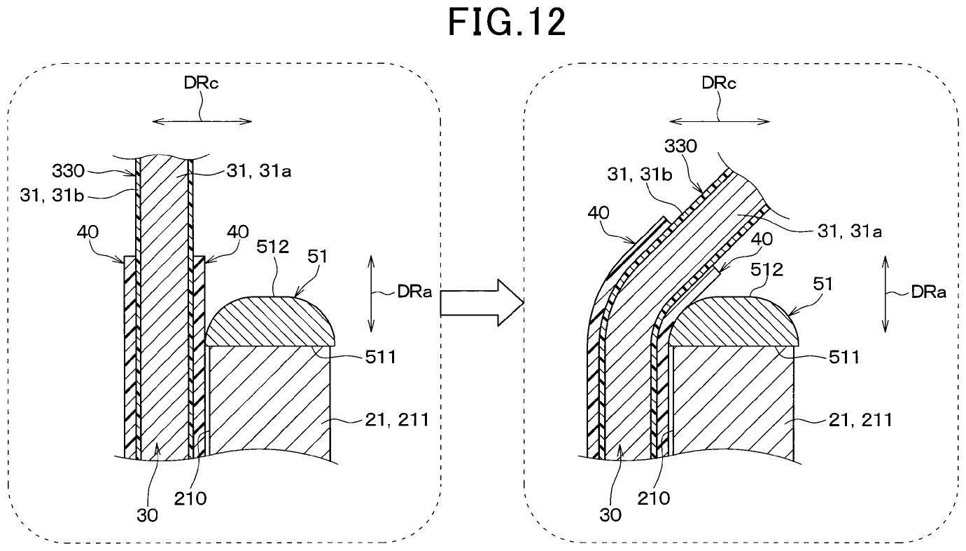

Moreover, in the present embodiment, as shown in FIG. 11, each of the bending jigs 51 is configured so that upon arrangement of the bending jig 51 on the second axial end face 20b of the stator core 20, the circumferential width of the press surface 512 of the bending jig 51 is larger than the circumferential width of the main body 211 of the corresponding tooth 21 at the same radial position. That is, on a cross section taken along the circumferential direction DRc, the circumferential width Wj of the press surface 512 of the bending jig 51 is larger than the circumferential width Wt of the main body 211 of the corresponding tooth 21. Consequently, in the bending step, it becomes possible to bring the corresponding protruding parts 330 of the electrical conductor segments 31 into contact with the press surface 512 of the bending jig 51 while keeping the corresponding protruding parts 330 out of contact with the main body 211 of the corresponding tooth 21.

In addition, the above dimensional relationship between the circumferential width Wj of the press surface 512 of the bending jig 51 and the circumferential width Wt of the main body 211 of the corresponding tooth 21 is specified at the same radial position. That is, the above dimensional relationship does not indicate that the maximum value of the circumferential width Wt of the main body 211 of the corresponding tooth 21 is smaller than the minimum value of the circumferential width Wj of the press surface 512 of the bending jig 51.

The bending jigs 51 are employed to form the second coil end 33 of the stator coil 30 into a desired shape. Therefore, it is desirable for the bending jigs 51 to be formed of a material having both high rigidity and a high yield point. More particularly, in the present embodiment, the bending jigs 51 are formed of a material (e.g., steel) having both a higher Young's modulus and a higher yield point than the insulating coats 31b of the electrical conductor segments 31.

Next, the bending step of the manufacturing method of the stator 14 according to the present embodiment will be described in more detail with reference to FIGS. 9-12.

In the bending step, first, the bending jigs 50 are arranged on the second axial end face 20b of the stator core 20 in such a manner as to allow the protruding parts 330 of the electrical conductor segments 31 to be bent without making contact with the second axial end face 20b of the stator core 20. More specifically, as indicated with an arrow A in FIG. 9, each of the bending jigs 51 is inserted radially inward between two groups of the protruding parts 330 of the electrical conductor segments 31 which are located respectively on opposite circumferential sides of the corresponding tooth 21 of the stator core 20.

Upon arrangement of the bending jigs 51 on the second axial end face 20b of the stator core 20, the protruding parts 330 of the electrical conductor segments 31 are bent, by the processing device 52, along the press surfaces 512 of the corresponding bending jigs 51. More specifically, the distal end portions of the protruding parts 330 of the electrical conductor segments 31 are first inserted in the corresponding receiving grooves 531 of the shaping plate 53. Then, the lift unit moves up and down the shaping plate 53 while rotating the same in the circumferential direction DRc, thereby bending the protruding parts 330 of the electrical conductor segments 31 along the press surfaces 512 of the corresponding bending jigs 51.

In addition, as described above, in the insertion step, the insulating sheets 40 are also inserted into the slots 210 of the stator core 20 so that parts of the insulating sheets 40 protrude, together with the protruding parts 330 of the electrical conductor segments 31, from the second axial end face 20b of the stator core 20. Therefore, in the subsequent bending step, as shown in FIG. 12, each of the insulating sheets 40, which is interposed between a corresponding one of the bending jigs 51 and the corresponding protruding parts 330 of the electrical conductor segments 31, is gently bent, together with the corresponding protruding parts 330, along the press surface 512 of the corresponding bending jig 51.

After the bending of the protruding parts 330 of the electrical conductor segments 31, the bending jigs 51 are removed from the second axial end face 20b of the stator core 20 radially outward. At the same time, the lift unit moves up and down the shaping plate 53, causing the distal end portions of the protruding parts 330 of the electrical conductor segments 31 to be detached out from the corresponding receiving grooves 531 of the shaping plate 53. Then, the bending step terminates.

According to the present embodiment, it is possible to achieve the following advantageous effects.

In the present embodiment, each of the bending jigs 51 is configured so that upon arrangement of the bending jig 51 on the second axial end face 20b of the stator core 20, the circumferential width Wj of the press surface 512 of the bending jig 51 is larger than the circumferential width Wt of the main body 211 of the corresponding tooth 21.

With the above configuration, in the bending step, it becomes possible to bend the protruding parts 330 of the electrical conductor segments 31 (i.e., the stator coil 30) along the press surfaces 512 of the corresponding bending jigs 51 while keeping the protruding parts 330 out of contact with the second axial end face 20b of the stator core 20.

That is, in the present embodiment, the protruding parts 330 of the electrical conductor segments 31 are bent not along both the second axial end face 20b of the stator core 20 and the press surfaces 512 of the corresponding bending jigs 51, but along only the press surfaces 512 of the corresponding bending jigs 51. Consequently, it becomes possible to bend the protruding parts 330 of the electrical conductor segments 31 with reference to the manufacturing apparatus 50, not to the manufactured product (i.e., the stator 14). As a result, it becomes possible to ensure the accuracy of dimensions and shape of the resultant stator coil 30.

Moreover, even when the actual positional relationship between the second axial end face 20b of the stator core 20 and the press surfaces 512 of the bending jigs 51 is deviated from a desired positional relationship, it will still be possible to form the second coil end 33 of the stator coil 30 into a stable curved shape conforming to the press surfaces 512 of the bending jigs 51.

Hence, according to the present embodiment, it becomes possible to manufacture the stator 14 without causing variation in the shape of the stator coil 30.

Furthermore, in the present embodiment, the stator coil 30 (i.e., the electrical conductor segments 31) is kept out of contact with the second axial end face 20b of the stator core 20 in the bending step. Consequently, it becomes possible to prevent the insulating coat 31b of the stator coil 30 from being damaged due to contact between the stator coil 30 and the second axial end face 20b of the stator core 20. For example, when there is a burr formed in the vicinity of the second axial end face 20b during the machining of the stator core 20, it will be possible to prevent the insulating coat 31b of the stator coil 30 from being damaged by the burr.

Moreover, in the present embodiment, in the bending step, each of the bending jigs 51 is inserted radially inward between two groups of the protruding parts 330 of the electrical conductor segments 31 which are located respectively on opposite circumferential sides of the corresponding tooth 21 of the stator core 20. Consequently, it becomes possible to arrange the bending jigs 51 on the second axial end face 20b of the stator core 20 without causing interference between the bending jigs 51 and the protruding parts 330 of the electrical conductor segments 31. Moreover, it also becomes possible for each of the bending jigs 51 to be shared by the two groups of the protruding parts 330 of the electrical conductor segments 31. Consequently, it becomes possible to simplify the bending step; it also becomes possible to reduce the parts count of the manufacturing apparatus 50.

In the present embodiment, each of the bending jigs 51 has the press surface 512 thereof configured as a curved surface having at least one radius of curvature. In the bending step, each of the bending jigs 51 is arranged on the second axial end face 20b of the stator core 20 so as to allow the corresponding protruding parts 330 of the electrical conductor segments 31 to be bent without making contact with the second axial end face 20b of the stator core 20.

With the above configuration of the press surfaces 12 of the bending jigs 51, it becomes possible to mitigate stress acting on the insulating coat 31b of the stator coil 30 during the bending of the protruding parts 330, thereby protecting the insulating coat 31b. Moreover, with the above arrangement of the bending jigs 51 on the second axial end face 20b of the stator core 20, it becomes possible to prevent the insulating coat 31b of the stator coil 30 from being damaged due to contact between the stator coil 30 and the second axial end face 20b of the stator core 20.

In the present embodiment, between the stator coil 30 and each of the teeth 21 of the stator core 20, there is interposed one of the insulating sheets 40 to electrically insulate the stator coil 30 (i.e., the electrical conductor segments 31) from the stator core 20. In the bending step, the insulating sheets 40 are also bent, together with the corresponding protruding parts 330 of the electrical conductor segments 31, in the circumferential direction DRc.

As described previously, in the present embodiment, the stator coil 30 (i.e., the electrical conductor segments 31) is kept out of contact with the second axial end face 20b of the stator core 20 in the bending step. Accordingly, it is difficult for the insulating sheets 40 interposed between the stator coil 30 and the teeth 21 of the stator core 20 to make contact with the second axial end face 20b of the stator core 20 in the bending step. Consequently, the insulating sheets 40 can be prevented from being damaged due to contact with the second axial end face 20b of the stator core 20.

In addition, according to the above-described manufacturing method known in the art, the protruding parts 330 of the electrical conductor segments 31 would be bent along both the second axial end face 20b of the stator core 20 and the press surfaces 512 of the corresponding bending jigs 51. In this case, the stator coil 30 (i.e., the electrical conductor segments 31) would be placed in intimate contact with the stator core 20. Consequently, it would be difficult to secure a space for arranging an adhesive member between the stator core 20 and the stator coil 30.

In contrast, in the present embodiment, the stator coil 30 is kept out of contact with the second axial end face 20b of the stator core 20 in the bending step. Consequently, it becomes possible to secure the spaces for arranging the resin layers 42 of the insulating sheets 40, which serve as adhesive members, between the stator core 20 and the stator coil 30. In other words, it becomes possible to have the adhesive members (i.e., the resin layers 42 of the insulating sheets 40) suitably interposed between the stator core 20 and the stator coil 30. As a result, it becomes possible to firmly fix the stator coil 30 to the stator core 20 with the adhesive members.

Moreover, with the stator coil 30 firmly fixed to the stator core 20, it becomes possible to suppress micro-vibration caused by the Lorentz force generated in the stator coil 30 during operation of the rotating electric machine 10. That is, according to the present embodiment, it becomes possible to lower vibration and noise of the rotating electric machine 10.

In addition, with the adhesive members suitably filled between the stator core 20 and the stator coil 30, it becomes possible to improve the heat transfer coefficient between them, thereby facilitating the transfer of heat from the stator coil 30 to the stator core 20. Consequently, it becomes possible to suppress increase in the temperature of the stator coil 30; thus it also becomes possible to suppress increase in the electrical resistance of the stator coil 30 due to increase in the temperature of the same. As a result, it becomes possible to improve the energy efficiency of the rotating electric machine 10. Furthermore, since the temperature margin with respect to the heatproof temperature of the stator coil 30 is increased, the stator coil 30 can be supplied with an increased amount of electric current, thereby increasing the output of the rotating electric machine 10.

In the present embodiment, the bending jigs 51 are formed of a material having a higher Young's modulus than the insulating coat 31b of the stator coil 30.

Consequently, it becomes possible to secure high rigidity of the bending jigs 51, thereby making it difficult for the bending jigs 51 to be deformed during the bending of the corresponding protruding parts 330 along the press surfaces 512 thereof. As a result, it becomes possible to suppress variation in the shape of the stator coil 30.

Moreover, in the present embodiment, the bending jigs 51 are formed of a material having a higher yield point than the insulating coat 31b of the stator coil 30.

Consequently, it becomes difficult for the bending jigs 51 to be deformed during the bending of the corresponding protruding parts 330 along the press surfaces 512 thereof. As a result, it becomes possible to suppress variation in the shape of the stator coil 30.

In addition, when there is variation in the shape of the stator coil 30, it may become difficult to dissipate heat from a heat-generating part of the rotating electric machine 10, resulting in an excessive increase in the temperature of the heat-generating part. In this case, the protector 60 would frequently operate to limit the output of the rotating electric machine 10, so as to suppress increase in the temperature of the heat-generating part.

In contrast, according to the present embodiment, variation in the shape of the stator coil 30 can be suppressed, thereby preventing frequent operation of the protector 60.

### Modifications of First Embodiment

In the above-described first embodiment, the stator 14 is configured so that parts of the insulating sheets 40 protrude, together with the protruding parts 330 of the electrical conductor segments 31, from the second axial end face 20b of the stator core 20. However, the stator 14 may alternatively be configured so that only the protruding parts 330 of the electrical conductor segments 31 protrude from the second axial end face 20b of the stator core 20.

In the above-described first embodiment, each of the insulating sheets 40 is configured to have the substrate 41 and the resin layers 42 integrally formed therein, so as to serve both as an insulating member and an adhesive member. However, each of the insulating sheets 40 may alternatively be configured to include only the substrate 41 that is electrically insulative. In this case, adhesive members may be interposed between the insulating sheets 40 and the stator core 20 and between the insulating sheets 40 and the stator coil 30.

### Second Embodiment

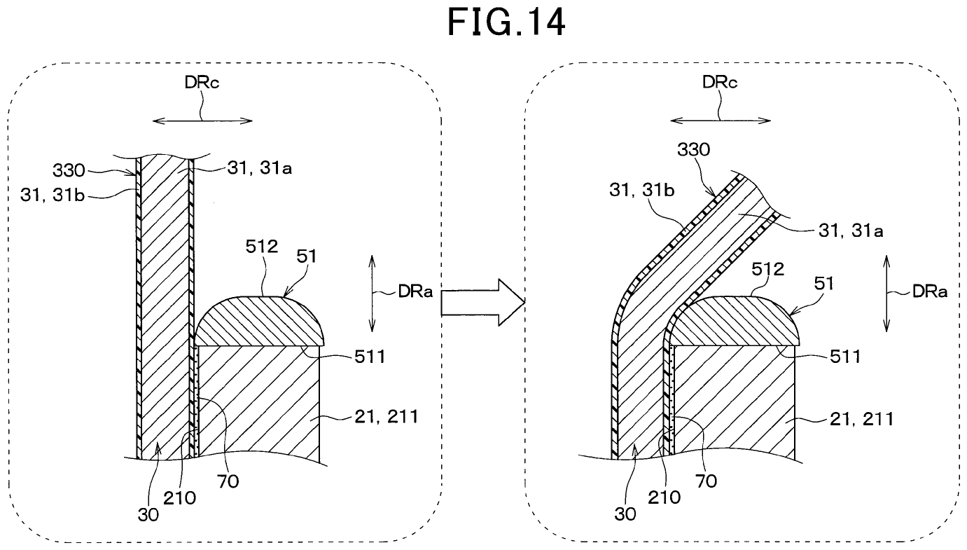

As shown in FIG. 13, a stator 14 according to the second embodiment includes no insulating sheets 40. Instead, the stator 14 according to the second embodiment has an adhesive 70 provided in each of the slots 210 of the stator core 20 to join (or fix) the stator coil 30 to the stator core 20.

Specifically, in each of the slots 210, the adhesive 70 is interposed between an interior wall surface of the stator core 20 defining the slot 210 and the electrical conductor segments 31 (i.e., the stator coil 30) inserted in the slot 210. More particularly, in the present embodiment, the adhesive 70 is implemented by a high-viscosity adhesive (e.g., a two-liquid mixture type epoxy resin adhesive) filled between the interior wall surface of the stator core 20 and the electrical conductor segments 31. As an alternative, the adhesive 70 may be implemented by a tablet type adhesive that is in a solid state at room temperature and fluidized upon being heated. As another alternative, the adhesive 70 may be implemented by an impregnated material that is obtained by impregnating a fabric tube with a low-viscosity adhesive.

Moreover, in a bending step of a method of manufacturing the stator 14 according to the present embodiment, as shown in FIG. 14, the protruding parts 330 of the electrical conductor segments 31 are gently bent along the press surfaces 512 of the corresponding bending jigs 51. As described previously in the first embodiment, each of the bending jigs 51 is configured so that the circumferential width of the press surface 512 of the bending jig 51 is larger than the circumferential width of the main body 211 of the corresponding tooth 21 at the same radial position. Consequently, in the bending step, it becomes possible to bend the protruding parts 330 of the electrical conductor segments 31 along the press surfaces 512 of the corresponding bending jigs 51 while keeping the protruding parts 330 out of contact with the main bodies 211 of the corresponding teeth 21.

Moreover, in a joining step of the manufacturing method of the stator 14 according to the present embodiment, the adhesive 70, which is filled between the interior wall surfaces of the stator core 20 defining the slots 210 and the electrical conductor segments 31, is cured upon the elapse of a predetermined curing time. Consequently, the stator coil 30 is fixed to the stator core 20 with the adhesive 70.

According to the present embodiment, it is possible to achieve the same advantageous effects as described in the first embodiment.

In particular, according to the present embodiment, the stator coil 30 is kept out of contact with the second axial end face 20b of the stator core 20 in the bending step. Consequently, it becomes possible to secure the spaces for providing the adhesive 70 between the stator core 20 and the stator coil 30. In other words, it becomes possible to have the adhesive 70 suitably interposed between the stator core 20 and the stator coil 30. As a result, it becomes possible to firmly fix the stator coil 30 to the stator core 20, thereby lowering vibration and noise of the rotating electric machine 10.

While the above particular embodiments and modifications have been shown and described, it will be understood by those skilled in the art that various further modifications, changes and improvements may be made without departing from the spirit of the present disclosure.

For example, in the above-described embodiments, each of the bending jigs 51 is configured so that the circumferential width of the press surface 512 of the bending jig 51 is larger than the circumferential width of the main body 211 of the corresponding tooth 21 at the same radial position over the entire radial range of the press surface 512. However, each of the bending jigs 51 may alternatively be configured so that the circumferential width of the press surface 512 of the bending jig 51 is smaller than the circumferential width of the main body 211 of the corresponding tooth 21 at the same radial position in part of the entire radial range of the press surface 512.

In the above-described embodiments, each of the press surfaces 512 of the bending jigs 51 is configured as a curved surface having at least one radius of curvature. However, each of the press surfaces 512 of the bending jigs 51 may alternatively be configured as a discontinuous curved surface, e.g., may alternatively be configured to include a flat surface as a part thereof.

In the above-described embodiments, the bending jigs 51 are formed of a material having both a higher Young's modulus and a higher yield point than the insulating coat 31b of the stator coil 30. However, the bending jigs 51 may alternatively be formed of a material having the same level Young's modulus or the same level yield point as the insulating coat 31b of the stator coil 30.

In the above-described embodiments, in the bending step, each of the bending jigs 51 is inserted radially inward between two groups of the protruding parts 330 of the electrical conductor segments 31 which are located respectively on opposite circumferential sides of the corresponding tooth 21 of the stator core 20. However, each of the bending jigs 51 may alternatively be inserted in the axial direction DRa between the two groups of the protruding parts 330 of the electrical conductor segments 31.

In the above-described embodiments, the stator coil 30 (i.e., the electrical conductor segments 31) is formed of an electric wire that includes an electrical conductor 31a with a substantially rectangular cross section and an insulating coat 31b covering the outer surface of the electrical conductor 31a. However, the stator coil 30 may alternatively be formed of an electric wire that includes a bundle of round electrical conductor wires and an insulating coat covering the bundle.

In the above-described embodiments, the stator 14 is employed in the rotating electric machine 10 that includes the protector 60. However, the stator 14 may alternatively be applied to a rotating electric machine that includes no protector 60.

In the above-described embodiments, the stator 14 is employed in the rotating electric machine 10 that is configured as an automotive alternator. However, the stator 14 may alternatively be applied to other rotating electric machines, such as an electric motor or a motor-generator that can selectively function as either an electric motor or an electric generator.

In the above-described embodiments, elements constituting the embodiments are not necessarily essential unless they are explicitly specified as being essential or are considered to be obviously essential in principle.

In the above-described embodiments, the numbers, the numerical values, the quantities and/or the ranges of elements constituting the embodiments are not particularly limited unless they are explicitly specified as being particularly limited or are considered to be obviously particularly limited in principle.

In the above-described embodiments, the shapes of and the positional relationships between elements constituting the embodiments are not particularly limited unless they are explicitly specified as being particularly limited or are considered to be obviously particularly limited in principle.

What is claimed is:

1. A method of manufacturing a stator for a rotating electric machine,
the stator comprising:
a hollow cylindrical stator core having a plurality of teeth arranged at predetermined intervals in a circumferential direction of the stator core and a plurality of slots each of which is formed between one circumferentially-adjacent pair of the teeth; and
a stator coil mounted on the stator core so as to be received in the slots of the stator core, the stator coil including an electrical conductor and an insulating coat covering the electrical conductor,
the method comprising steps of:
inserting the stator coil into the slots of the stator core so as to have a plurality of parts of the stator coil protruding from an axial end face of the stator core, the protruding parts together constituting a coil end of the stator coil; and
bending the protruding parts of the stator coil in the circumferential direction,
wherein
in the bending step:
a bending jig, which has a press surface, is arranged on the axial end face of the stator core to cover at least part of a corresponding one of the teeth of the stator core; and
at least one of the protruding parts of the stator coil is pressed against the press surface of the bending jig, thereby being bent in the circumferential direction,
wherein
a circumferential width of the press surface of the bending jig is larger than a circumferential width of a facing part of the corresponding tooth of the stator core, the facing part facing the at least one of the protruding parts of the stator coil in the circumferential direction.

2. The method as set forth in claim 1, wherein in the bending step, the bending jig is inserted, in a radial direction of the stator core, between at least one pair of the protruding parts of the stator coil located respectively on opposite circumferential sides of the corresponding tooth of the stator core.

3. The method as set forth in claim 1, wherein the press surface of the bending jig is configured as a curved surface having at least one radius of curvature, and
in the bending step, the bending jig is arranged on the axial end face of the stator core so as to allow the at least one of the protruding parts of the stator coil to be bent without making contact with the axial end face of the stator core.

4. The method as set forth in claim 1, wherein between the stator coil and each of the teeth of the stator core, there is interposed an insulating member to electrically insulate the stator coil from the stator core, and
in the bending step, the insulating member interposed between the at least one of the protruding parts of the stator coil and the bending jig is also bent, together with the at least one of the protruding parts, in the circumferential direction.

5. The method as set forth in claim 1, wherein the bending jig is formed of a material having a higher Young's modulus than the insulating coat of the stator coil.

6. The method as set forth in claim 1, wherein the bending jig is formed of a material having a higher yield point than the insulating coat of the stator coil.

7. The method as set forth in claim 1, wherein the rotating electric machine comprises a protector that is configured to limit an output of the rotating electric machine upon the temperature of a heat-generating part of the rotating electric machine exceeding a predetermined threshold temperature.

8. The method as set forth in claim 1, further comprising, after the bending step, a step of fixing the stator coil to the stator core with an adhesive member.

9. An apparatus for manufacturing a stator for a rotating electric machine,
the stator comprising:
a hollow cylindrical stator core having a plurality of teeth arranged at predetermined intervals in a circumferential direction of the stator core and a plurality of slots each of which is formed between one circumferentially-adjacent pair of the teeth; and
a stator coil mounted on the stator core so as to be received in the slots of the stator core, the stator coil having a plurality of protruding parts that protrude from an axial end face of the stator core and together constitute a coil end of the stator coil,
the apparatus comprising:
a bending jig having a press surface and configured to be arranged on the axial end face of the stator core to cover at least part of a corresponding one of the teeth of the stator core; and
a pressing device configured to press at least one of the protruding parts of the stator coil against the press surface of the bending jig, thereby bending the at least one of the protruding parts in the circumferential direction,
wherein
a circumferential width of the press surface of the bending jig is larger than a circumferential width of a facing part of the corresponding tooth of the stator core, the facing part facing the at least one of the protruding parts of the stator coil in the circumferential direction.
